(19) United States
(12) Patent Application Publication
(10) Pub. No.: US 2026/0367421 A1
(43) Pub. Date: Nov. 19, 2026

(54) NOSE PAD ATTACHMENT FOR EYEWEAR

(71) Applicant: Group Medical Supply LLC, Chanhassen, MN (US)

(72) Inventor: Joseph A Cerami, III, Belle Plaine, MN (US)

(21) Appl. No.: 19/676,281

(22) Filed: May 13, 2026

Related U.S. Application Data
(60) Provisional application No. 63/807,039, filed on May 16, 2025.

(51) Int. Cl. G02C 5/12

(52) U.S. Cl. CPC G02C 5/126

(57) ABSTRACT

A nose pad attachment for eyewear is disclosed. The nose pad attachment disclosed includes a body structure shaped to form a raised top and base and an inner cavity formed within the body structure bounded by an inner surface of the base and an inner surface of the raised top. The nose pad is attached to eyewear via an adhesive on the undersurface of the base of the body structure to connect the nose pad to eyewear.

### CROSS-REFERENCES TO RELATED APPLICATIONS

This application claims priority to Provisional Application Ser. No. 63/807,039 entitled “NOSE PAD ATTACHMENT FOR EYEWEAR” filed May 16, 2025, which is hereby incorporated by reference in its entity into the present application.

### BACKGROUND

The present application relates to a nose pad for eyewear. Nose pads provide an interface between a user's nose and a hard surface of nose pieces for eyewear. Nose pads can enhance comfort for eyewear or glasses and provide a gripping surface to hold glasses in place. The present application relates to an improved nose pad that is designed to improve comfort and wearability of glasses and that provides advantages over the prior art.

### SUMMARY

The present application relates to a nose pad attachment for eyewear. The nose pad attachment disclosed includes a body structure shaped to form a raised top and base and an inner cavity formed within the body structure bounded by an inner surface of the base and an inner surface of the raised top. The nose pad is attached to eyewear via an adhesive on the undersurface of the base of the body structure to connect the nose pad to eyewear. In illustrated embodiments, the body structure includes an underside opening between the inner surface and undersurface of the base opened to the inner cavity. The underside opening is covered by a dual sided adhesive structure to form a sealed chamber of the nose pad. In particular as disclosed, the dual sided adhesive includes an upper adhesive layer supported on an upper substrate surface to attach to the undersurface of the base and a lower adhesive layer on a lower substrate surface to attach the nose pad to eyewear. In illustrated embodiments, the body structure has a semicircular profile to form a straight front edge on a front side of the nose pad and a curved back edge on a back side of the nose pad. The front side of the raised top is shaped to form a concaved surface profile to provide a front side contoured surface indentation as described and illustrated. Additional features of the nose pad attachment of the present application are described and shown herein.

### BRIEF DESCRIPTION OF THE DRAWINGS

FIG. 1A illustrates an embodiment of eyeglasses or eyewear having a nose bridge and nose pieces.

FIG. 1B illustrates a nose pad attachment attached to nose pieces of the eyewear shown in FIG. 1A.

FIG. 2A is a detailed perspective illustration of an embodiment of the nose pad attachment of the present application supported on a lubricous sheet.

FIG. 2B is a top view of the nose pad attachment of FIG. 2A removed from the lubricous sheet.

FIG. 2C is a bottom view illustrating a nose pad adhesive on an underside of the nose pad attachment of FIGS. 2A-2B.

FIG. 3A is a cross-sectional view taken along line 3A-3A of FIG. 2B

FIG. 3B is a cross-sectional view taken along line 3B-3B of FIG. 2B

FIG. 3C is an exploded view illustrating the body structure of the nose pad attachment and adhesive structure on an underside of the body structure of the nose pad attachment.

FIG. 4A is a partial view and cross-section of the body structure of the nose pad attachment illustrated in FIG. 3C.

FIG. 4B illustrates an undersurface of a body structure of the pad body illustrated in FIG. 4A.

FIG. 5A illustrates fabrication steps for an embodiment of the nose pad attachment of the present application.

FIG. 5B is a detailed view illustrating attachment of the nose pad attachment to a nose piece of eyewear.

### DETAILED DESCRIPTION OF ILLUSTRATIVE EMBODIMENTS OF THE INVENTION

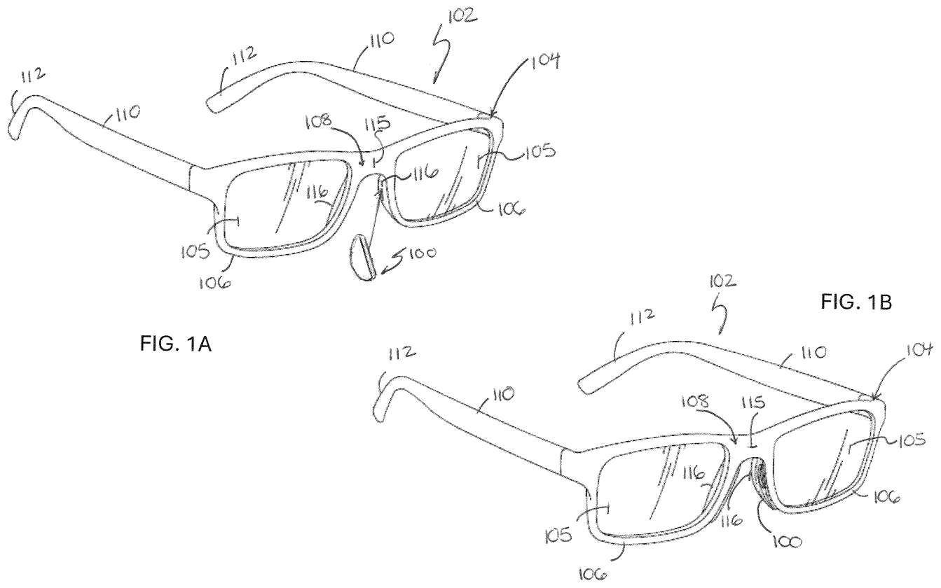

The present application relates to a nose pad attachment 100 for eyewear or eyeglasses 102. As shown in FIG. 1A, eyeglasses 102 include a frame structure 104 and lenses 105 coupled to the frame structure 104. As shown, the frame structure 104 includes spaced rims 106 connected through a nose bridge 108. Lenses 105 are connected to the rims 106 of the frame structure 104 for use. In the illustrated embodiment, the frame structure 104 includes opposed arms 110 connected to rims 106 through a hinged connection (not shown) to secure the eyeglasses to the user's face. In the illustrated embodiment, an extended end of arms 110 have a contoured tip 112 to support the frame structure 104 on the user's ears. As shown, the nose bridge 108 includes a bridge connector 115 between spaced rims 106 and nose pieces 116. As shown in FIG. 1B, the nose pad attachment 100 attaches to the nose pieces 116 of the nose bridge 108 to enhance comfort and support of eyewear or glasses on the user's face.

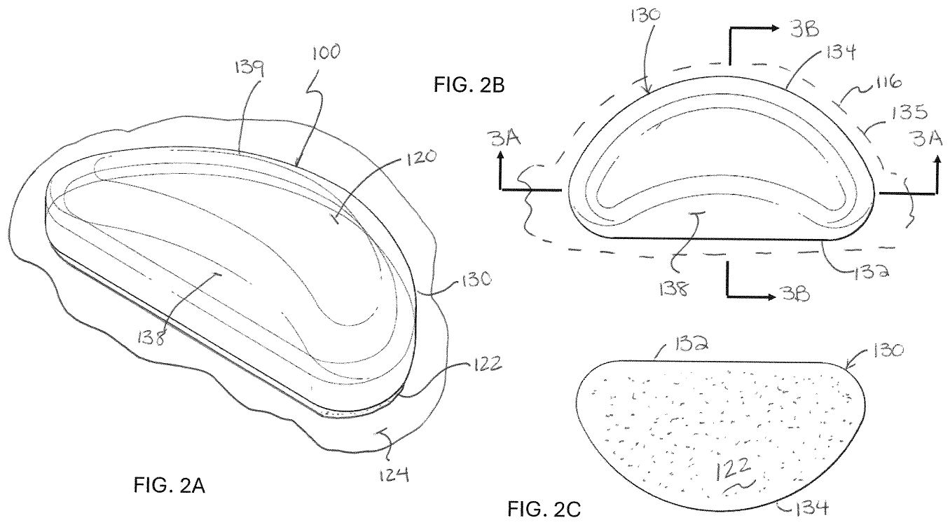

FIGS. 2A-2C illustrate an embodiment to the nose pad attachment 100 of the present application. As shown, the nose pad attachment 100 has a pad body 120 and a nose pad adhesive 122 on an underside of the pad body for connecting the nose pad attachment to the nose pieces 116 of eyewear. As shown in FIG. 2A, prior to use, the nose pad adhesive is supported on a lubricous sheet 124 to protect the nose pad adhesive 122 prior to attachment to the nose pieces 116 of the eyewear. The pad body 120 has generally semicircular profile shape 130 that forms a generally straight 132 edge along a front side of the pad body or nose pad attachment and a curved edge 134 along a back side of the pad body shaped to follow the contour 135 of curved shaped nose pieces 116 (shown in phantom in FIG. 2B). As shown, the front side of pad body 120 has a generally concaved surface profile 138 to hug the user's nose and the back side has a rounded surface profile 139. For use as shown in FIG. 2C, the nose pad adhesive is released from the lubricous sheet 124 for attachment to the nose pieces 116 or eyewear.

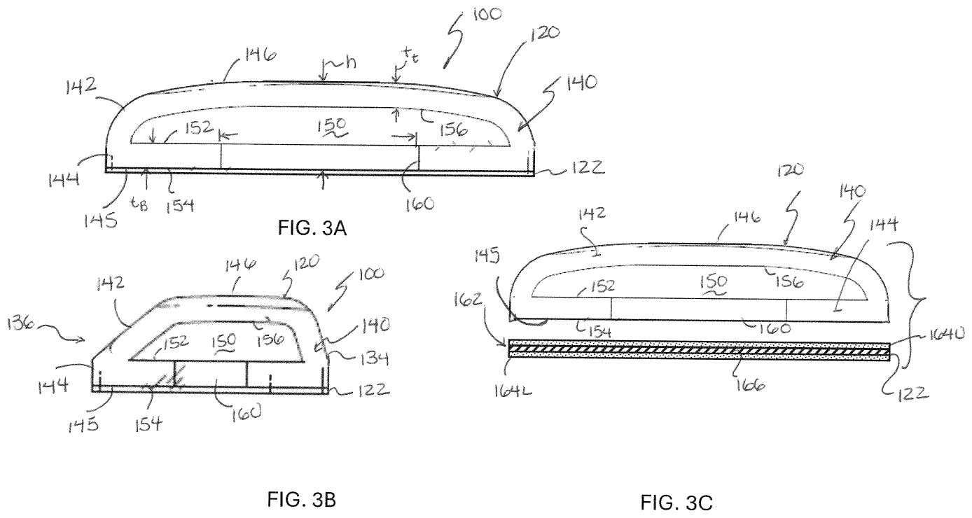

In the illustrated embodiment shown in FIGS. 3A-3C, the pad body 120 is formed of a body structure 140 shaped to form a raised top 142 and base 144. A height -h- of the body structure 140 extends from an underside 145 of the body structure 140 to an upper surface 146 of the raised top. As shown, the body structure 140 is shaped to form an inner cavity 150 within body structure having cavity boundary formed by the raised top 142 and base 144. In particular, the body structure 140 is shaped to form a base thickness t_{b} between an inner surface 152 of the base 144 and an undersurface 154 of the base along the underside 145 of the body structure and a top thickness tt between an inner surface 156 of the raised top and the upper surface 146 of the raised top 142. The body structure 140 is formed of a compliant material to provide a “squishy” nose pad attachment 100. Illustratively the compliant material of the body structure is a silicone material.

In the embodiment shown, the base 144 of the body structure 140 has an underside opening 160 extending between the underside 145 of the body structure to the inner cavity 150. As shown, the underside opening 160 extends from the undersurface 154 of the base 144 to the inner surface 152 of the base to provide a passage to the inner cavity 150. As shown, the underside opening 160 has a smaller perimeter dimension than a perimeter of the inner cavity 150 at a base of the inner cavity 150 proximate to the base 144 of the body structure 140. As shown, the shape and geometry of the underside opening 160 and cavity 150 allow desired flexure and compression of the raised top for optimum comfort and function of the nose pad attachment.

As previously disclosed, the nose pad attachment includes a nose pad adhesive 122 on the underside 145 of the body structure 140 to attach the nose pad to eyewear. In the embodiment shown in FIG. 3C, the nose pad adhesive 122 is formed of an adhesive structure 162 to adhere the nose pad attachment 100 to nose pieces 116 as described. In the illustrated embodiment shown, the adhesive structure 162 adheres to the underside of the body structure 140 to close the underside opening 160 to form a sealed inner cavity 150. In an illustrated embodiment as shown in FIG. 3C, the adhesive structure 162 is a dual sided adhesive including a first or upper adhesive layer 164U on a first side of a substrate 166 and a second or lower adhesive layer 164L on a underside of the substrate 166. As shown, the upper adhesive layer 164U is adhered to the undersurface 154 of the base 144 to form the closed or sealed inner cavity 150 and the lower adhesive layer 164L is adhered to nose pieces 116 to attach the nose pad to eyewear for use. As disclosed, the enclosed inner cavity 150 distributes pressure across the raised top 142 of the pad body 120 to enhance comfort.

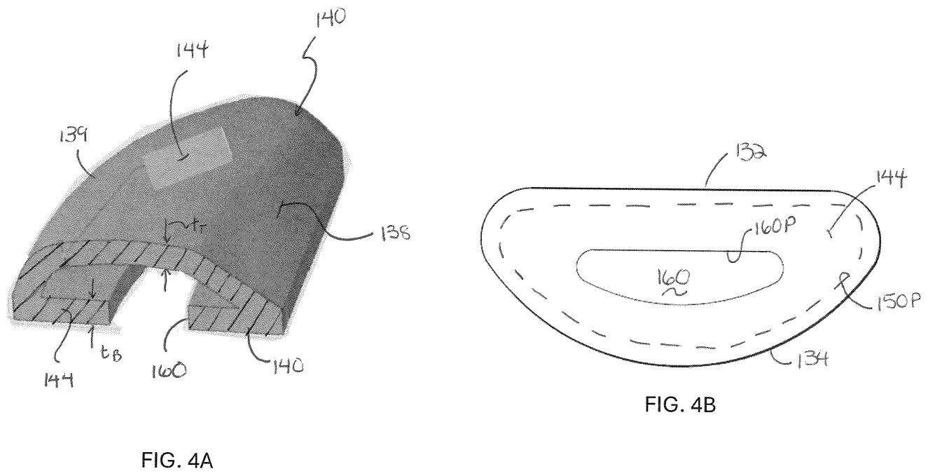

FIG. 4A is a partial perspective view of a portion of the body structure 140 of the nose pad attachment 100 illustrating the raised top 142 and base 144 of the body structure 140. In the illustrated embodiment, as cooperatively shown in FIGS. 4A-4B, the underside opening 160 is generally oval shaped however application is not limited to a particular shape opening. As shown in FIG. 4B, the base 144 has a generally oval shape surrounding the oval shaped underside opening 160. In particular, a perimeter 150P of the inner cavity 150 (illustrated in phantom) and perimeter 160P of the underside opening 160 are shown in FIG. 4B. As shown in FIG. 4A, the raised top 142 of the body structure 140 is shaped to form the concaved surface profile 138 on the front side of the nose pad attachment and front side contoured surface indentation of the nose pad. The shape of the raised top also forms the rounded surface profile 139 on the back side of the nose pad attachment as shown.

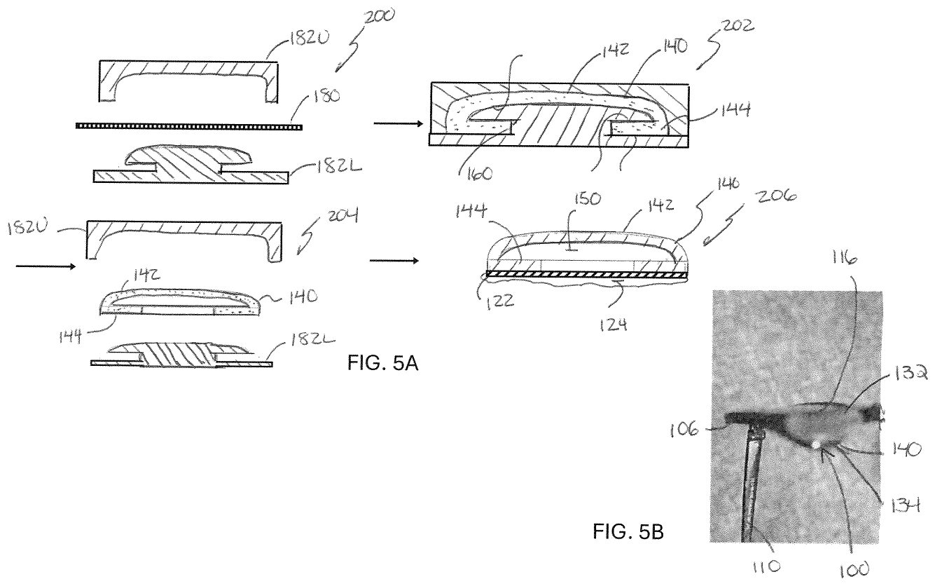

FIG. 5A illustrates process steps for fabricating the nose pad attachment 100 of the present application. As described, the nose pad attachment is fabricated of an elastomer material such as a silicone or other material. In the illustrated embodiment, the body structure 140 is shaped or molded from a sheet 180 of silicone or elastomeric material. As shown, the moldable sheet 180 has a uniform thickness dimension and is placed between upper and lower mold parts 182U, 182L of a mold assembly to form the raised top 142 having a contoured surface profile and base 144. In the embodiment described, the raised top 142 and base 144 of the body structure 140 have a generally uniform wall thickness corresponding a thickness of sheet 180. The upper mold part 182U is contoured to form the raised top 142 and the lower mold part 182L is shaped to form the inner surface of the raised top 142; inner surface and undersurface of the base 144; underside opening 160; and inner cavity 150.

As comparatively shown in steps 200 and 202, the upper and lower mold parts 182U, 182L are closed and heat and pressure are applied to the upper and lower mold parts 182U, 182L to form body structure 140 of the nose pad attachment from sheet 180 as described. In step 204, the upper and lower mold parts 182U, 182L are separated to release the molded body structure 140 of the nose pad attachment. In step 206 the nose pad adhesive is adhered to the underside of the base to form the assembled nose pad attachment 100. In the illustrated embodiment of FIG. 5A, the nose pad adhesive is formed of a dual sided adhesive structure having an upper adhesive layer 164U attached to the undersurface 154 of the base 144 to close the cavity 150 and lower adhesive layer 164L attachable to the nose pieces 116 of eyewear. Prior to attachment of the adhesive in step 206, the molded body structure 140 is cooled and polished to remove burrs and imperfections. In illustrated embodiments, the assembled nose pad attachment 100 is fed through an edge cutting machine to trim edges and remove excess material. In the illustrated embodiment shown, the lower adhesive layer of the adhesive structure is releasably supported on a lubricous sheet which can be precut or subsequently cut and trimmed.

FIG. 5B illustrates the nose pad attachment of the present application secured to a nose piece 116 or eyewear. As shown, the nose pad attachment 100 is adhered so that the front side 136 of the nose pad attachment 100 faces forward and the curved back side 134 faces towards the user's face to contour to the user's nose. As described, the molded body structure 140 is formed of a soft, flexible, lightweight elastomer material for comfort and wearability. In an illustrated embodiment, the elastomeric material is a silicone material mixed with one or more additive(s) through a vulcanization process to enhance durability and flexibility. In an illustrative embodiment, the one or more additives include an anti-slip agent to enhance grip to reduce slippage.

While the present application discloses illustrative embodiments of the present invention, application is not limited to the particular embodiments disclosed and changes and modifications can be made as will be appreciated by those skilled in the art.

1. A nose pad attachment for eyewear comprising:
a body structure shaped to form a raised top and base and a height of the body structure extending from an underside of the body structure to an upper surface of the raised top and the body structure having a base thickness between an inner surface of the base and an undersurface of the base along the underside of the body structure;
an inner cavity formed within the body structure having a cavity boundary formed by the inner surface of the base and an inner surface of the raised top spaced from the upper surface of the raised top; and
a nose pad adhesive having a dual sided adhesive structure including an upper adhesive layer adhered to the undersurface of the base of the body structure and a lower adhesive layer to attach the nose pad attachment to eyewear.

2. The nose pad attachment of claim 1 wherein the body structure includes an underside opening along the base of the body structure extending from the undersurface of the base to the inner surface of the base and opened to the inner cavity and the dual sided adhesive structure covers the underside opening of the base to seal the inner cavity.

3. The nose pad attachment of claim 2 wherein a perimeter dimension of the underside opening is smaller than a perimeter dimension of the inner cavity.

4. The nose pad attachment of claim 1 wherein the upper adhesive layer is on an upper side of a substrate layer and the lower adhesive layer is on a lower side of the substrate layer and a release liner covers the lower adhesive layer.

5. The nose pad attachment of claim 1 wherein the body structure is formed of a silicone material.

6. The nose pad attachment of claim 1 wherein the body structure is generally semi-circular shaped to form a semi-circular shaped nose pad attachment having a generally straight edge on a front side of the nose pad attachment and a curved edge on a back side of the nose pad attachment.

7. The nose pad attachment of claim 1 wherein a front surface of the raised top of body structure has a concaved surface profile on a front side of the nose pad attachment to form a contoured surface indentation on the front side of the nose pad attachment.

8. The nose pad attachment of claim 1 wherein the base and the raised top of the body structure have a generally uniform thickness dimension.

9. A nose pad attachment for eyewear comprising:
a body structure having a body thickness shaped to form a raised top extending from a base of the body structure and an inner cavity having a cavity boundary formed by an inner surface of the raised top and an inner surface of the base spaced from an underside of the body structure;
an underside opening on the underside of the body structure extending through a thickness of the base between the inner surface of the base and an undersurface of the base along the underside of the body structure and opened to the inner cavity; and
a nose pad adhesive on the undersurface of the body structure.

10. The nose pad attachment of claim 9 wherein the nose pad adhesive is formed of a double-sided adhesive structure having an upper adhesive layer to adhere to the undersurface of the base and a lower adhesive layer to adhere to the eyewear.

11. The nose pad attachment of claim 10 wherein the upper and lower adhesive layers are supported on upper and lower sides of a substrate and the lower adhesive layer is on a releasable liner.

12. The nose pad attachment of claim 9 wherein body structure has a semi-circular profile shaped to form a generally straight front edge along a front side of the nose pad attachment and a curved edge along a back side of the nose pad attachment.

13. The nose pad attachment of claim 9 wherein a front surface of the raised top of body structure on a front side of the nose pad attachment has a concaved surface profile to form a contoured surface indentation on the front side of the nose pad attachment.

14. The nose pad attachment of claim 9 wherein the base and the raised top of the body structure have a generally uniform thickness dimension.

15. The nose pad attachment of claim 9 wherein the underside opening has a smaller perimeter dimension than a perimeter dimension of the inner cavity at the base of the nose pad attachment.

16. A method for forming a nose pad for eyewear comprising the steps of:
providing a moldable sheet having a thickness between opposed surfaces of the moldable sheet;
shaping the moldable sheet to form a body structure of the nose pad having a raised top and inner cavity formed within the body structure between an inner surface of a base of the body structure and an inner surface of the raised top and the base having an underside opening extending from an undersurface of the base to the inner surface of the base and opened to the inner cavity; and
applying a nose pad adhesive to the undersurface of the base to seal the underside opening and inner cavity.

17. The method of claim 16 wherein the step of shaping the moldable sheet includes positioning the moldable sheet between upper and lower mold pieces of a mold assembly;
closing the upper and lower mold pieces to shape the body structure and inner cavity;
separating the upper and lower mold pieces; and
removing the molded body structure from the mold assembly prior to applying the nose pad adhesive to the undersurface of the base.

18. The method of claim 17 wherein the upper mold piece forms an upper surface of the raised top and the lower mold piece includes a raised mold top and stem and the raised mold top forms the raised top of the body structure with the upper mold piece and the stem forms the underside opening through the base of the molded body structure and the step of removing the molded body structure includes the step of apply force to elastically stretch the base of the body structure over the raised mold top to release the body structure from the lower mold piece.

19. The method of claim 18 wherein the upper mold piece and the raised mold top of the lower mold piece are shaped to form a concaved surface profile on a front side of the body structure to provide a contoured surface indentation on the front side of the nose pad attachment.

20. The method of claim 16 wherein the step of applying the nose pad adhesive to the undersurface of the base comprises the steps of applying an upper adhesive layer of a double sided adhesive structure to the undersurface of the base to connect the double sided adhesive structure to the body structure of the nose pad attachment.
